(19) United States
(12) Patent Application Publication
(10) Pub. No.: US 2003/0055934 A1
(43) Pub. Date: Mar. 20, 2003

(54) Computer aided dispatch system and method for automatically distributing current status information to mobile units

(76) Inventor: Shane Lincke, Cantonment, FL (US)

Correspondence Address: PENNIE AND EDMONDS, 1155 AVENUE OF THE AMERICAS, NEW YORK, NY, 100362711

(21) Appl. No.: 09/960,418

(22) Filed: Sep. 20, 2001

(51) Int. Cl. G06F 15/173; G06F 15/16

(52) U.S. Cl. 709/223; 709/203

(57) ABSTRACT

A computer aided dispatch system that automatically provides real time status information regarding calls and mobile unit availability to the mobile units. In a preferred embodiment of the present invention, call status information and mobile unit status information are stored in a CAD CALL and CAD UNIT database, respectively, on a server in the dispatch center. As changes are made to these databases, either by the dispatcher or by other means, the changes are substantially instantaneously broadcast to the mobile units. Preferably, a display screen in each mobile unit will display substantially the same call status and unit status details that the dispatcher sees on his or her computer display.

### FIELD OF THE INVENTION

The present invention relates generally to a computer aided dispatch system and method and, more particularly, to a computer aided dispatch system and method in which current status information is automatically and substantially instantaneously distributed to and displayed on mobile units.

### BACKGROUND OF THE INVENTION

Computer Aided Dispatch (CAD) systems are used by public safety agencies, such as law enforcement, fire departments and emergency medical services, to track incoming calls and the units that respond to them. Typically, a call is received by a dispatcher at a dispatch center and the dispatcher will either assign one or more mobile units to respond to the call or will broadcast information about the call to all the mobile units and one or more mobile units will choose on their own to respond. Communications between the dispatch center and the mobile units is commonly via some form of wireless communication. For example, when a 911 call is received, a dispatcher typically uses the CAD system to determine the caller's street address and to enter information about the nature of the call. Law enforcement and/or emergency personnel are then dispatched and the dispatcher uses the CAD system to monitor the status of the call and the responding units until the situation is resolved. Known CAD systems typically use a client-server configuration in which a server located at a dispatch center or other central location is accessed by client-workstations residing in mobile units. In these types of systems, requests for information originate at the mobile units (i.e., the clients).

One disadvantage of known CAD systems is that the information entered by the dispatcher is typically not replicated in real time to the mobile units. Instead the mobile units must periodically poll the dispatch center to receive updated call status information. Even if this polling takes place every few minutes, valuable time in responding to calls may be lost. For example, a law enforcement officer may get on an interstate highway to respond to a minor incident, not knowing a call came in 30 seconds earlier for a major incident in the opposite direction. It may take the officer many minutes to then turn around and respond to the major incident; minutes that would not have been lost had he received the information regarding all incidents in real time.

In addition, because the mobile units do not have real time status information, dispatchers are often left the task of assigning priority levels to different incidents. However dispatchers typically do not have the experience of veteran personnel in the field to assign who needs to go where, to determine how to handle a call and to make sure that all incidents are adequately covered. If veteran field personnel received call information in real time they would be in a position to make many of the important decisions now made by often less experienced dispatchers.

There is thus an important need for a CAD system that provides detailed real time status information to mobile units.

### SUMMARY OF THE INVENTION

It is therefore an object of the present invention to provide real time status information to mobile units in a CAD system so that field personnel can be aware of and act upon this information.

It is a further object of the present invention to provide a CAD system that supplies detailed information to mobile units so that experienced field personnel can be less dependent on the judgment of dispatchers.

The above and other objects are realized by the system and method of the present invention. Briefly, the present invention provides real time status information regarding calls and mobile unit availability to the mobile units in a CAD system. In a preferred embodiment of the present invention, call status information and mobile unit status information are stored in a CAD CALL and CAD UNIT database, respectively, on a server in the dispatch center. As changes are made to these databases, either by the dispatcher or by other means, the changes are substantially instantaneously broadcast to the mobile units. Preferably, a display screen in each mobile unit will display substantially the same call status and unit status details that the dispatcher sees on his computer display.

Field personnel having mobile units are thus able to view call and mobile unit status changes as the changes are entered into the CAD system. This allows experienced field personnel, such as officers and supervisors, to see what is happening in real time and use their experience to make changes in unit assignments to suit the situation. As a result, field personnel respond to calls more quickly and make better decisions with the information at their disposal. Another benefit of the invention is that it reduces airwave traffic because the mobile units are not requesting information or acknowledging the receipt of information. Airwave traffic is also reduced because only information regarding new calls or calls that have changed are transmitted.

### BRIEF DESCRIPTION OF THE DRAWINGS

FIG. 1 illustrates the basic hardware setup of a preferred embodiment of the present invention;

FIG. 2 is a flow chart illustrating a process in accordance with a preferred embodiment of the present invention;

FIG. 3 is a flow chart illustrating the process of automatically and substantially instantaneously providing call and unit status information to mobile units;

FIG. 4 illustrates the general format of an entry in the CAD CALL data table;

FIG. 5 illustrates the general format of an entry in the CAD UNIT data table; and

FIG. 6 is a sample screen that would be displayed on dispatchers' workstations and on the display screens of mobile units in accordance with an embodiment of the present invention.

### DETAILED DESCRIPTION OF THE PREFERRED EMBODIMENTS

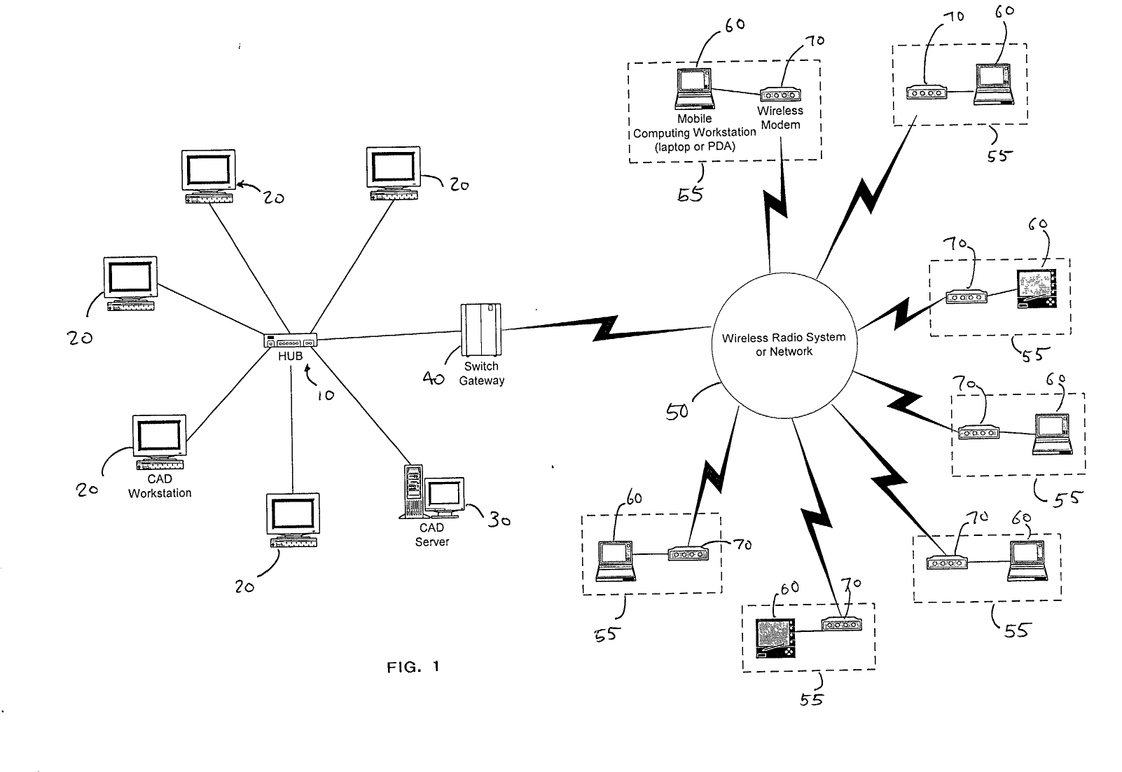

FIG. 1 shows the basic hardware setup of an embodiment of the present invention. CAD workstations 20, CAD server 30 and switch gateway 40 are each connected to central hub 10. The central hub 10 is a means of implementing a network and enables the devices connected to it to communicate with each other. Of course, other network configurations and other means for communicating information among these devices may be used. The CAD workstations 20, CAD server 30, switch gateway 40 and central hub 10 are typically, but not necessarily, located in a central dispatch center.

CAD workstations 20 are operated by dispatchers and are used to enter information regarding incoming calls and the status of the mobile units that may respond to the calls. CAD server 30 contains, or can access, databases that store call and unit information received from CAD workstations 20, and possibly other sources, such as mobile units. Switch gateway 40 controls communications between the hub, and the devices connected to it, and various mobile units. Preferably, switch gateway 40 and the mobile units send and receive information via a wireless radio system or network 50. Switch gateway 40 preferably includes a software message switch for sending and receiving messages over different types of communications systems.

The mobile units 55, referred to herein as mobile computer terminals (MCTs), preferably each comprise a mobile computing workstation (MCW) 60, such as a laptop computer, personal digital assistant (PDA), or other computing device, possibly mounted in a vehicle, and a wireless modem 70. The wireless modem enables the MCT 55 to send and receive information via the wireless network 50. An MCT 55 may be mounted in a vehicle such as, for example, a police car, ambulance, aircraft or boat.

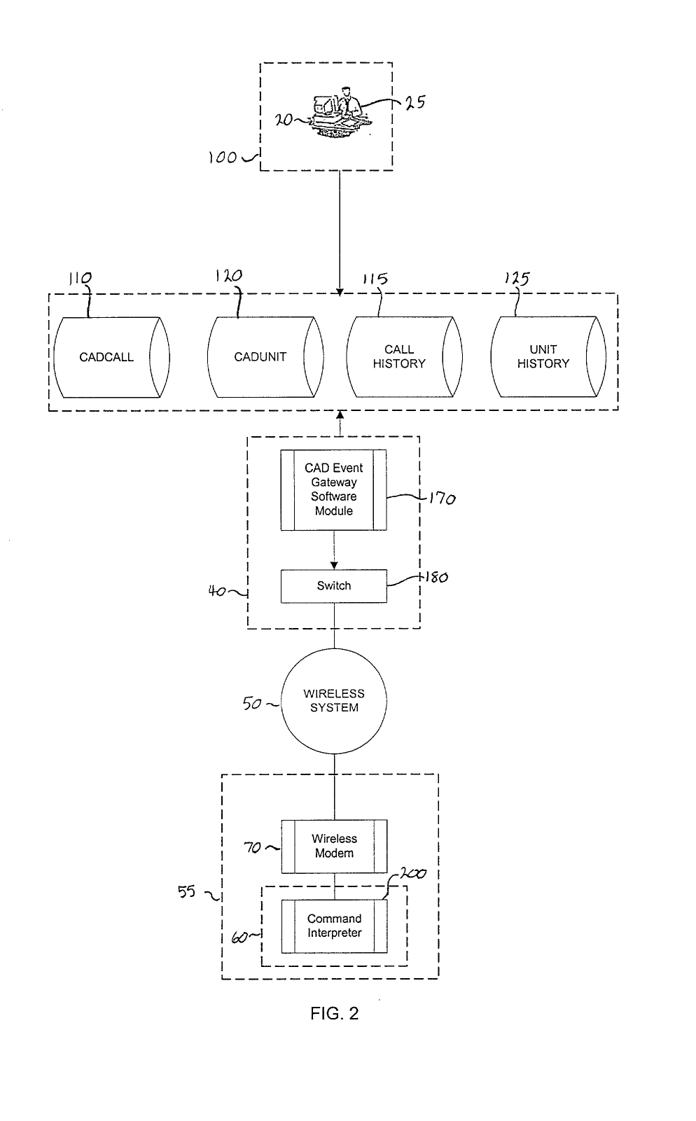

Turning now to FIG. 2, CAD server 30 is shown containing four data tables:

CAD CALL 110, CAD UNIT 120, CALL HISTORY 115, and UNIT HISTORY 125.

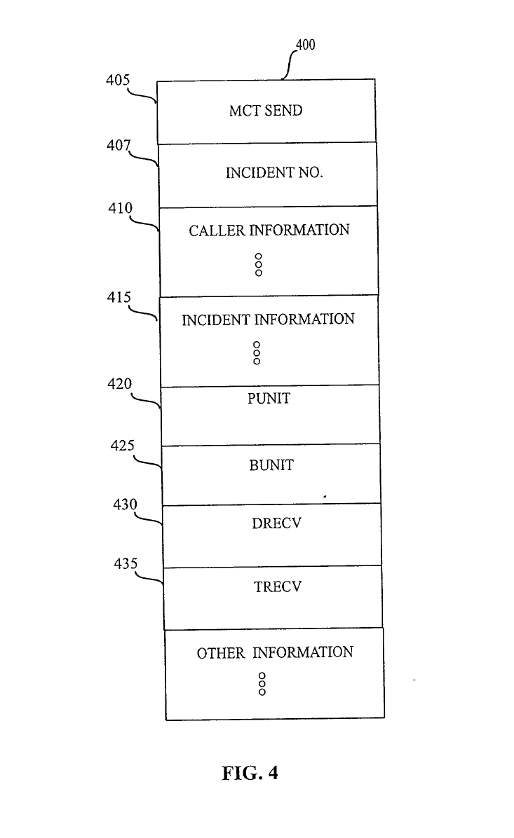

CAD CALL 110 contains incident information pertaining to active calls that are entered into and tracked by the CAD system. FIG. 4 shows the general format of an entry 400 in CAD CALL table 110. MCTSEND field 405 is used in automatically sending current status information to mobile units, as described below. INCIDENTNO field 407 contains a unique identifier for each record in CAD CALL table 110. CALLER INFORMATION 410 is typically multiple fields that contain information regarding the caller who called the dispatch center, such as the caller's name, phone number, address and location from which the call was placed. INCIDENT INFORMATION 415 is typically multiple fields that contain information regarding the incident or complaint being reported, such as the nature of the incident or complaint and the location of the incident or complaint. PUNIT field 420 identifies the primary unit responding to the call. BUNIT 425 is typically multiple fields that identify back up units responding to the call. DRECV field 430 and TRECV field 435 contain the date and time the call was received. Those skilled in the art will appreciate that CAD CALL table entry 400 may also contain additional and different types of information. CAD CALL table 110 is used to track calls until the response to the call has been completed or the call has been canceled.

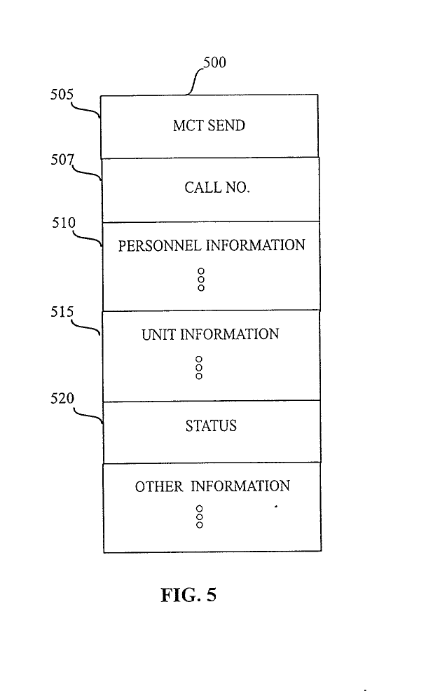

CAD UNIT 120 contains information pertaining to active units, such as police, fire and emergency vehicles, their assigned personnel, and the incidents they are handling. FIG. 5 shows the general format of an entry 500 in CAD UNIT table 120. MCTSEND field 505 is used in automatically sending current status information to mobile units, as described below. CALLNO field 507 contains a unique identifier for each record in CAD UNIT table 120. PERSONNEL INFORMATION 510 is typically multiple fields that contain information regarding the personnel assigned to the mobile unit, such as his or her name and rank and the agency to which he or she belongs. UNIT INFORMATION 515 is typically multiple fields that contain information regarding the mobile unit, such as its position, its primary geographic location and information regarding the last call to which the unit was assigned. STATUS field 520 provides information regarding the status of the mobile unit, for example, whether it is available to go on a call, is currently on a call, or is on a break. Again, those skilled in the art will appreciate that CAD UNIT table entry 500 may also contain additional and different types of information. Based on CAD UNIT table 120, the CAD system can preferably display any combination of units by their status or location.

CALL HISTORY table 115 and UNIT HISTORY table 125 provide archival information regarding deleted calls and units that are off duty, respectively. The general format of entries in CALL HISTORY table 115 and UNIT HISTORY table 125 are similar to that for CAD CALL table 110 and CAD UNIT table 120, respectively.

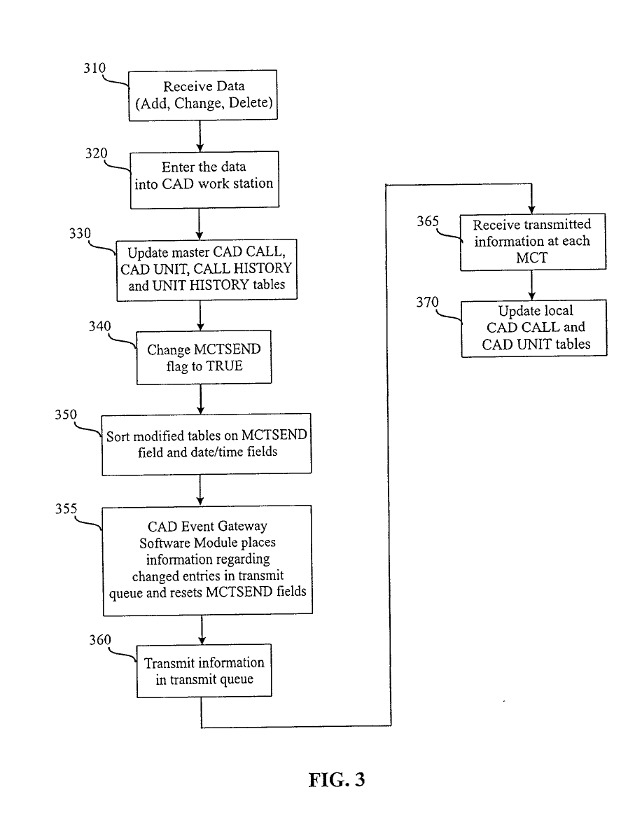

Each MCW 60 contains a local copy of the CAD CALL and CAD UNIT data tables. The local copies are synchronized with the master database on CAD server 30 as shown in FIG. 3, discussed below.

Referring back to FIG. 2, box 100 illustrates that information to be stored in the data tables in CAD Server 30 may be input, for example, by a dispatcher 25 at CAD workstation 20. Alternatively, information may be received from an MCT 55 or some other computer via a wireless modem or some other wireless or direct connection.

Switch gateway 40 includes a CAD Event Gateway Software Module 170 that automatically detects changes in the CAD CALL, CAD UNIT, CALL HISTORY and UNIT HISTORY tables and sends those changes to MCTs 55 via switch 180 and wireless system 50. Switch 180 is preferably, though not necessarily, in switch gateway 40. The transmitted changes are interpreted by an interpreter module 200, which resides in each MCW 60.

FIG. 3 illustrates the process by which changes to the master CAD CALL, CAD UNIT, CALL HISTORY and UNIT HISTORY data tables are automatically and substantially instantaneously distributed to the MCTs 55. In step 310, a dispatcher receives information regarding a new call or unit or a change to or deletion of an existing call or unit. In step 320, the dispatcher enters the data on a CAD workstation 20. Preferably, the CAD workstation and CAD server will alert the dispatcher if a call reporting an apparently new incident is in fact related to an incident that has already been reported based on the proximity in time and location of the two calls. In step 330, CAD Server 30 updates the CAD CALL, CAD UNIT, CALL HISTORY and UNIT HISTORY tables, based on the information entered by the dispatcher at CAD workstation 20. In the case of a new call or unit, a new entry is added to the CAD CALL or CAD UNIT data tables. Preferably, in the case of a new call, CAD server 30 is programmed to recommend to the dispatcher which unit or units should respond based upon each unit's geographic assignments (beats, districts, precincts, etc.), the type of incident (high danger, low danger), and type of unit (patrol, supervisor, canine, etc.). In the case of a change to an existing call or unit, the appropriate CAD CALL or CAD UNIT entry is changed. In the case that a call or unit is to be deleted, the appropriate CAD CALL or CAD UNIT entry is deleted and a new entry, corresponding to the deleted entry, is added to the CALL HISTORY or UNIT HISTORY table. In all cases, in step 340, the CAD server 30 changes the MCTSEND flag for the new, changed or deleted entry in the CAD CALL, CAD UNIT, CALL HISTORY or UNIT HISTORY table to TRUE. In step 350, the CAD server 30 then sorts the data table that had a new or changed entry on the MCTSEND field and, secondarily, on fields containing the time the entry was added or changed. This causes all data entries having an MCTSEND flag set to TRUE to be listed at the beginning of the data tables.

In step 355, CAD Event Gateway Software Module 170 in switch gateway 40 determines, for each of the CAD CALL, CAD UNIT, CALL HISTORY and UNIT HISTORY tables, if any entries have their MCTSEND field set to TRUE. Again, such entries, if they exist, will appear at the beginning of the data tables because the data tables are sorted on the MCTSEND field. Software Module 170 preferably either constantly monitors the tables or periodically examines them at intervals set by the public service agency. For each such entry, software module 170 places information about the addition, change or deletion on a transmit queue and resets the MCTSEND field to FALSE. This information may have the same or similar format as a CAD CALL table entry 400 or CAD UNIT table entry 500. In step 360, message switch 180 broadcasts the information in the queue to all MCTs, deleting the information after it is broadcast. Preferably, all entries in the CAD CALL and CAD UNIT tables are additionally periodically broadcast at an interval set by the public service agency to ensure that all MCTs 55 are synchronized with the master tables.

Steps 365 and 370 are performed on each of the MCTs. As mentioned above, each MCT 55 contains local shadow versions of the CAD CALL and CAD UNIT data tables. In step 365, the MCT 55 receives, preferably via wireless modem 70, the information broadcast from message switch 180. Finally, in step 370, a command interpreter 200 running on MCT 55, interprets the received information and makes the appropriate addition, modification or deletion to the local CAD CALL or CAD UNIT data table. The modifications to the local data tables are preferably reflected substantially instantaneously on the display of MCW 60.

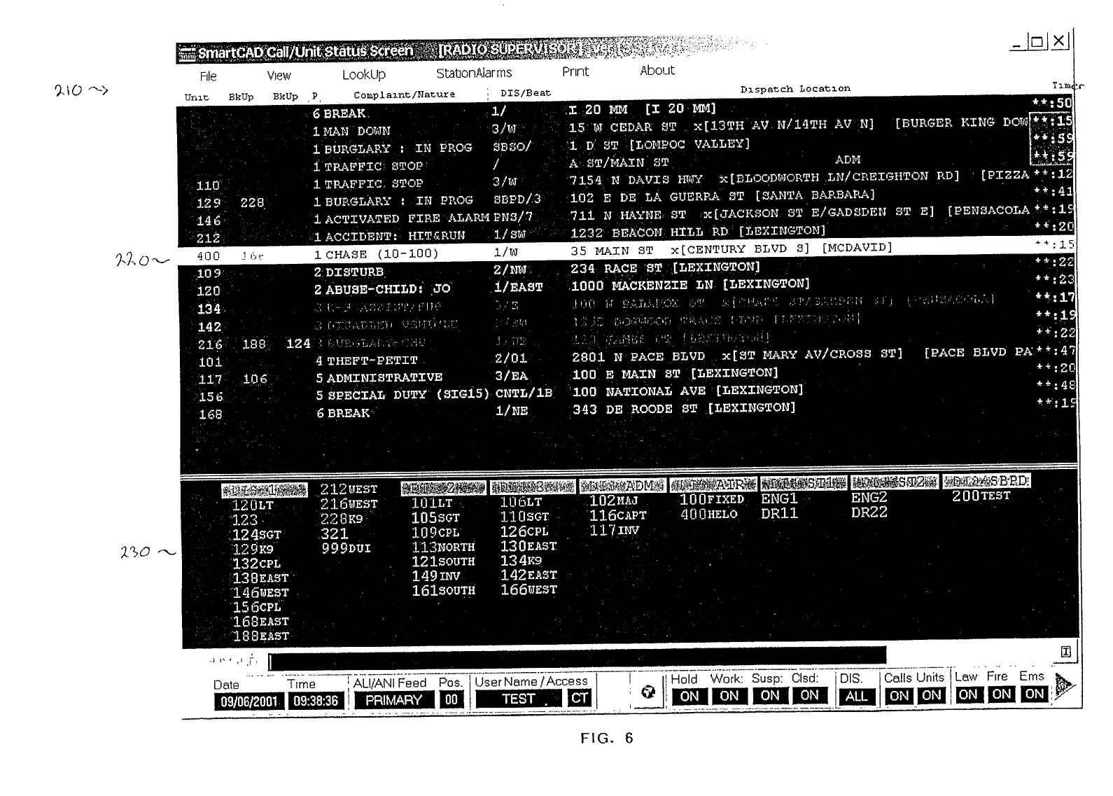

FIG. 6 depicts a sample screen 210 that would appear on CAD workstations 20 and MCWs 60. Again, since the local CAD CALL and CAD UNIT data tables on MCTs 55 are automatically and substantially instantaneously updated when changes are made to the master data tables, the screens 210 appearing on CAD workstations 20 and MCWs 60 are capable of presenting substantially identical information. As depicted, the top half 220 of the screen provides call information and the bottom half 230 provides unit information. Referring to the top half 220 of the screen, the Unit column identifies the primary unit assigned to the call; the BkUp columns identify back up units assigned to the call; the P column identifies the priority of the call; the Complaint/Nature column provides a description of the subject matter of the call; the Dis/Beat column identifies the general geographic area of the call; the Dispatch Location column identifies the location of the subject matter of the call; and the Timer column identifies the length of time the call has been active. A blank field in the Unit or BkUp columns means that a primary and/or back up unit has not yet been assigned. Referring to the bottom half 230 of the screen, the active units in DIS 1, DIS 2 and DIS 3 etc. are shown, where each “DIS” refers to a geographic district or area. The active units in each area are listed under the heading for that area. The units are identified, as shown, by a multi-character string. The first three characters of the string preferably contain a unique unit identification number and the remaining characters may contain a comment that describes, for example, the type of unit, the agency to which the unit is assigned, and/or the rank of the personnel in the unit.

For CAD workstations 20, but not necessarily MCWs 60, the bottom of the screen preferably contains a status bar providing the current date and time; the ALI/ANI Feed (911 feed information) and Pos. information (workstation number of the dispatcher), the user name and access level of the user of the CAD workstation, whether calls on hold, actively working, suspended and closed are being displayed, the geographic area or areas being displayed, whether one or both of call and unit information is being displayed, and whether calls for law enforcement, fire departments and emergency medical services are being displayed. Additional information about call or unit information may be displayed by clicking on the right arrow button in the lower right hand corner of the display. Preferably call priority information and unit information is color coded.

MCW 60 in MCT 55 also preferably contains software that enables a mobile user to make changes to the local CAD CALL and CAD UNIT data tables. In this case, these changes would be transmitted by MCW 60, via wireless modem 70 and wireless network 50 to switch gateway 40. Switch gateway 40, in turn, stores these messages in a received messages queue until they can be transmitted to CAD server 30 in the dispatch center. Once they are so transmitted, CAD server 30 updates the master data tables and transmits the changes to all other active MCTs as described above.

While the invention has been particularly shown and described with reference to particular illustrative embodiments thereof, it will be understood by those skilled in the art that various changes in form and details are within the scope of the invention, which is defined by the claims. For example, various functions and operations described above may be implemented in software or hardware and may be divided among multiple computers or other data processing devices.

What is claimed is:

1. A computer aided dispatch system comprising:
a master dispatch database comprising one or more data tables, each data table having one or more entries, each containing information pertaining to the dispatch of services by one or more mobile units;
a central dispatch computer system capable of accessing the master dispatch database;
one or more mobile terminals, comprising a processor and a local dispatch database;
wherein, whenever a change is made to the master dispatch database by the central dispatch computer system, the change is automatically sent by the central dispatch computer system to the one or more mobile terminals, which in turn each make a substantially similar change to its local dispatch database.

2. The system of claim 1 wherein the change is sent by the central dispatch computer system at substantially the same time the change is made to the master dispatch database.

3. The system of claim 2 wherein the change is one of an addition of a new entry in the master dispatch database, a modification of an existing entry in the master dispatch database, and a deletion of an entry in the master dispatch database.

4. The system of claim 3 wherein the master dispatch database comprises a master call data table and the local dispatch database on each mobile terminal comprises a local call data table, each entry in the master call data table and the local call data table containing information about a matter for which services must be dispatched.

5. The system of claim 4 wherein the master dispatch database further comprises a master unit data table and the local dispatch database on each mobile terminal further comprises a local unit data table, each entry in the master unit data table and the local unit data table containing information about one of the mobile units.

6. The system of claim 2 wherein the central dispatch computer system comprises
a dispatch server and
a gateway computer,
wherein the dispatch server is capable of making the change to the master dispatch database and the gateway computer is capable of accessing the master dispatch database and sending information about new, modified and deleted entries to the one or more mobile terminals.

7. The system of claim 6 wherein each entry in the master dispatch database comprises a send field, indicating whether the entry should be sent to the one or more mobile terminals.

8. The system of claim 7 wherein the gateway computer accesses the master dispatch database and sends to the one or more mobile terminals information regarding those entries in which the send field is set to indicate that the entry should be sent.

9. The system of claim 8 further comprising a switch attached to the gateway computer capable of wireless transmission and wherein the one or more mobile terminals further comprise a wireless modem that is attached to the processor.

10. A method of dispatching information pertaining to requests for service from a central dispatch computer system to one or more mobile terminals comprising the steps of:
accessing and changing, by the central dispatch computer, a master dispatch database comprising one or more data tables, each data table having one or more entries, each containing information pertaining to the dispatch of services by one or more mobile units;
automatically sending to the one or more mobile terminals change information pertaining to the change in the master dispatch database; and
changing a local dispatch database associated with each of the one or more mobile terminals based upon received change information.

11. The method of claim 10 wherein the step of automatically sending change information occurs at substantially the same time the change was made to the master dispatch database.

12. The method of claim 11 wherein the change is one of an addition of a new entry in the master dispatch database, a modification of an existing entry in the master dispatch database, and a deletion of an entry in the master dispatch database.

13. The method of claim 12 wherein the master dispatch database comprises a master call data table and the local dispatch database associated with each mobile terminal comprises a local call data table, each entry in the master call data table and the local call data table containing information about a matter for which services must be dispatched.

14. The method of claim 13 wherein the master dispatch database further comprises a master unit data table and the local dispatch database associated with each mobile terminal further comprises a local unit data table, each entry in the master unit data table and the local unit data table containing information about one of the mobile units.

15. The method of claim 11 wherein the central dispatch computer system comprises
a dispatch server and a gateway computer, and
wherein the step of accessing and changing the master dispatch database is performed by the dispatch server, and
wherein the step of sending change information further comprises accessing the master dispatch database by the gateway computer, and
sending information about new, modified and deleted entries to the one or more mobile terminals.

16. The method of claim 15 wherein each entry in the master dispatch database comprises a send field, indicating whether the entry should be sent to the one or more mobile terminals.

17. The method of claim 16 wherein the step of accessing the master dispatch database by the gateway computer further comprises identifying those entries in the master dispatch database in which the send field is set to indicate that the entry should be sent, and the step of sending information comprising sending information regarding the identified entries.

18. The method of claim 17 wherein the step of sending information to each of the one or more mobile terminals is performed via wireless transmission.
